(19) United States
(12) Patent Application Publication
(10) Pub. No.: US 2025/0216762 A1
(43) Pub. Date: Jul. 3, 2025

(54) BREATHING LIGHT MODULE AND ELECTRONIC DEVICE

(71) Applicant: GUANGDONG OPPO MOBILE TELECOMMUNICATIONS CORP., LTD., Dongguan (CN)

(72) Inventor: Xionghui PENG, Dongguan (CN)

(21) Appl. No.: 19/084,726

(22) Filed: Mar. 19, 2025

Related U.S. Application Data
(63) Continuation of application No. PCT/CN2023/111603, filed on Aug. 8, 2023.

(30) Foreign Application Priority Data
Sep. 20, 2022 (CN) 202211140870.X

(51) Int. Cl. G03B 30/00; F21V 8/00; H04M 1/02

(52) U.S. Cl. CPC G03B 30/00; G02B 6/0065; G02B 6/0068; G02B 6/0073; G02B 6/0088; G02B 6/009; G02B 6/0095; H04M 1/0264

(57) ABSTRACT

A breathing light module and an electronic device are provided. The breathing light module includes a light guide element having a first annular surface and a second annular surface arranged on two opposite sides respectively, wherein a groove is defined on a side of the light guide element where the first annular surface is located; a light source assembly, wherein a light emitting portion of the light source assembly is at least partially arranged within the groove, and the light emitting portion is configured to emit light towards the light guide element; a first reflective film, arranged on the first annular surface; and a second reflective film, arranged on the second annular surface. A coverage area is formed by the second reflective film covering on the second annular surface. An orthogonal projection of the light emitting portion on the second annular surface falls within the coverage area.

### CROSS REFERENCE TO RELATED APPLICATIONS

The present application is a continuation of International Patent Application No. PCT/CN2023/111603, filed Aug. 8, 2023, which claims priority to Chinese Patent Application No. 202211140870.X, filed Sep. 20, 2022, the entire disclosures of which are incorporated herein by reference.

### TECHNICAL FIELD

The present disclosure relates to the technical field of electronic devices, and in particular, to a breathing light module and an electronic device.

### BACKGROUND

With the development of electronic technology, electronic devices such as mobile phones, tablet computers, and the like have become an indispensable part of people's daily lives and work.

In related arts, a breathing light is usually placed near a camera to ensure that the camera and the breathing light, exposed outside the electronic device's casing, are coordinated and aesthetically pleasing as a whole.

However, the light emitted by the breathing light during operation tends to spread to a position of the camera, causing light crosstalk, which affects the normal operation of the camera, resulting in poor imaging quality, unrealistic photos and videos, and negatively impacting the user experience.

### SUMMARY

According to some embodiments of the present disclosure, a breathing light module and an electronic device are provided.

In a first aspect, the present disclosure provides a breathing light module, including:
a light guide element, having a first annular surface and a second annular surface arranged on two opposite sides respectively, with a groove defined on a side of the light guide element where the first annular surface is located;
a light source assembly, where a light emitting portion of the light source assembly is at least partially arranged within the groove, and the light emitting portion is configured to emit a light towards the light guide element;
a first reflective film, arranged on the first annular surface; and
a second reflective film, arranged on the second annular surface, where a coverage area is formed by the second reflective film covering on the second annular surface, and an orthogonal projection of the light emitting portion on the second annular surface falls within the coverage area.

In a second aspect, the present disclosure provides an electronic device, including a camera module and the above-mentioned breathing light module. The camera module faces the light guide element, and the light guide element is arranged to surround an optical axis of the camera module.

### BRIEF DESCRIPTION OF THE DRAWINGS

In order to more clearly illustrate the technical solutions of the embodiments of the present disclosure or the prior art, a brief introduction to the drawings required in the description of the embodiments or prior art will be provided below. It is evident that the drawings described below are only some embodiments of the present disclosure, and those skilled in the art can obtain other drawings based on these drawings without any creative effort.

FIG. 1 is a cross-sectional structural view of a breathing light module in some embodiments, with a camera module arranged corresponding to the light guide element being shown in FIG. 1.

FIG. 2 is a perspective structural view of a light guide element of a breathing light module in some embodiments.

FIG. 3 is a schematic view of a visual color mixing principle of a breathing light module in some embodiments.

FIG. 4 is a structural view of a breathing light module in some embodiments with a structure of the lightshade being shown in FIG. 4.

FIG. 5 is a schematic structural view of the breathing light module shown in FIG. 4 when a first decorative ring and a second decorative ring are arranged with a lightshade.

FIG. 6 is a rear schematic view of an electronic device in some embodiments.

FIG. 7 is a partial structural cross-sectional view of the electronic device shown in FIG. 6 along the I-I line.

FIG. 8 is an enlarged partial structural view of a circle A portion in FIG. 7.

FIG. 9 is a schematic structural view of an electronic device in some embodiments.

Reference numerals in the drawings:
10: breathing light module;
11: light guide element;
11a: first annular surface;
11b: second annular surface;
11c: groove;
11d: light concentrating portion;
11e: peripheral side surface;
12: light source assembly;
12a: light emitting portion;
12b: circuit board;
121: red LED light;
122: green LED light;
123: blue LED light;
13: first reflective film;
14: second reflective film;
15: lightshade;
151: Light-transmitting portion;
152: light-blocking portion;
15a: first stepped groove;
15b: second stepped groove;
16: first decorative ring;
17: second decorative ring;
17a: first stop wall;
17b: second stop wall;
17c: installation groove;
18: first adhesive layer;
19: second adhesive layer;
20: camera module;
20a: camera lens;
100: electronic device;
101: rear cover.

### DETAILED DESCRIPTION

The technical solutions of the embodiments of the present disclosure will be described clearly and completely below in conjunction with the drawings in the embodiments of the present disclosure. It is evident that the described embodiments are only part of the embodiments of the present disclosure and not all them. Any other embodiments derived by those skilled in the art based on the described embodiments of the present disclosure without creative effort should within the scope of protection of the present disclosure.

The term “electronic device” as used herein refers to a device that is capable of receiving and/or transmitting a communication signal and is connected by one or more of the following connection methods:
(1) Wired connection methods, such as through Public Switched Telephone Networks (PSTN), Digital Subscriber Line (DSL), digital cable, or direct cable connection;
(2) Wireless interface methods, such as cellular networks, Wireless Local Area Networks (WLAN), digital television networks like DVB-H, satellite networks, or AM-FM radio transmitters.

An electronic device that is configured to communicate via a wireless interface may be referred to as a “mobile terminal”. Examples of mobile terminals include, but are not limited to, the following electronic devices:
(3) Satellite phones or cellular phones;
(4) Personal Communication System (PCS) terminals, which may combine cellular radio phones with data processing, fax, and data communication capabilities;
(5) Radio phones, pagers, Internet/Intranet access devices, web browsers, notepads, calendars, and Personal Digital Assistants (PDA) equipped with Global Positioning System (GPS) receivers;
(6) Conventional laptop and/or handheld receivers;

(7) Conventional laptop and/or handheld radio telephone transceivers, etc.

The present disclosure provides a breathing light module, including:
a light guide element, having a first annular surface and a second annular surface arranged on two opposite sides respectively, with a groove defined on a side of the light guide element where the first annular surface is located;
a light source assembly, where a light emitting portion of the light source assembly is at least partially arranged within the groove, and the light emitting portion is configured to emit a light towards the light guide element;
a first reflective film, arranged on the first annular surface; and
a second reflective film, arranged on the second annular surface, where a coverage area is formed on the second annular surface, and an orthogonal projection of the light emitting portion on the second annular surface falls within the coverage area.

In some embodiments, a periphery of the light guide element is arranged with a light concentrating portion, the light concentrating portion is configured to converge the light incident on the light concentrating portion and emit the light from the periphery of the light guide element.

In some embodiments, the light concentrating portion includes multiple teeth, and the multiple sawteeth are sequentially arranged along the periphery of the light guide element.

In some embodiments, the light guide element has at least two grooves defined thereon, the periphery of the light guide element is arranged with at least two light concentrating portions, and the light concentrating portions are alternatively arranged along a circumferential direction of the light guide element.

In some embodiments, any interval between any one of the at least two grooves and an adjacent one of the at least two light concentrating portions is equal.

In some embodiments, the light source assembly includes a LED light, a position of a light emitting surface of the LED light forms the light emitting portion, and the LED light includes at least one of a red LED light, a green LED light, and a blue LED light.

In some embodiments, the red LED light, the green LED light, and the blue LED light are arranged in parallel in the groove, the green LED light is arranged at an inner side of the red LED light, the blue LED light is arranged on at outer side of the red LED light, and the inner side of the red LED light is a side facing a center of the light guide element.

In some embodiments, the breathing light module further includes a lightshade, which includes a light-transmitting portion and a light-blocking portion connected together, the lightshade covers the second annular surface and a peripheral side surface of the light guide element for enabling at least a part of the light-transmitting portion to face the light guide element; in condition of the light emitting portion emitting the light, the light guide element directs the light from the periphery of the light guide element to the light-transmitting portion, and the light is emitted from a periphery of the light-transmitting portion.

In some embodiments, the light-transmitting portion and the light-blocking portion are integrally formed through dual-color injection molding.

In some embodiments, the light-transmitting portion is made of transparent Polycarbonate 1250Z (PC) injected plastic material with 1% of white titanium dioxide and 1% of Ethylhexyl Triazone (T150) diffusion powder, and the light-blocking portion is made of gray PC1414 injected plastic material with 1% of white titanium dioxide.

In some embodiments, the lightshade is made of transparent plastic or transparent glass, and a light-blocking film is attached on a position of the lightshade corresponding to the light emitting portion, a position where the light-blocking film is attached forms the light-blocking portion, or the light-blocking portion is formed by ink sprayed onto the lightshade.

In some embodiments, a light transmission rate of the light guide element is 40% to 60%, and a thickness of the light guide element is 0.65 mm to 0.75 mm.

In some embodiments, a reflectance of the first reflective film and a reflectance of the second reflective film are both greater than or equal to 80%, a light transmission rate of the first reflective film is 0.3% to 0.5%, and a light transmission rate of the second reflective film is 0.2% to 0.4%.

In some embodiments, a material of the first reflective film and the second reflective film is white Polyethylene Terephthalate (PET).

In some embodiments, the first reflective film is double-sided adhesive tape, and the second reflective film is single-sided adhesive tape.

In some embodiments, a first stepped groove and a second stepped groove are defined on the light-transmitting portion, the first stepped groove is configured to arrange a first decorative ring therein, the second stepped groove is configured to arrange a second decorative ring therein, the first decorative ring is sealingly connected to a top surface of the light-transmitting portion, the second decorative ring is sealingly connected to a step surface of the second stepped groove, the light guide element is arranged on a side of the light-transmitting portion opposite to the second stepped groove, and an inner circle of the light guide element corresponds to an inner circle of the second decorative ring.

In some embodiments, an installation groove is defined on the second decorative ring, and the installation groove is configured to install a camera lens.

In some embodiments, the second decorative ring includes a first stop wall and a second stop wall, the first stop wall is arranged on the inner circle of the second decorative ring, the second stop wall is arranged on an outer circle of the second decorative ring, the first stop wall abuts an inner circle of the light-transmitting portion, and the second stop wall abuts an inner circle of the first decorative ring.

In some embodiments, the breathing light module further includes a first adhesive layer and a second adhesive layer, the first decorative ring is connected to the lightshade via the first adhesive layer, and the second decorative ring is connected to the lightshade via the second adhesive layer.

In some embodiments, the present disclosure further provides an electronic device, including a camera module and the above-mentioned breathing light module. The camera module faces the light guide element, and the light guide element is arranged to surround an optical axis of the camera module.

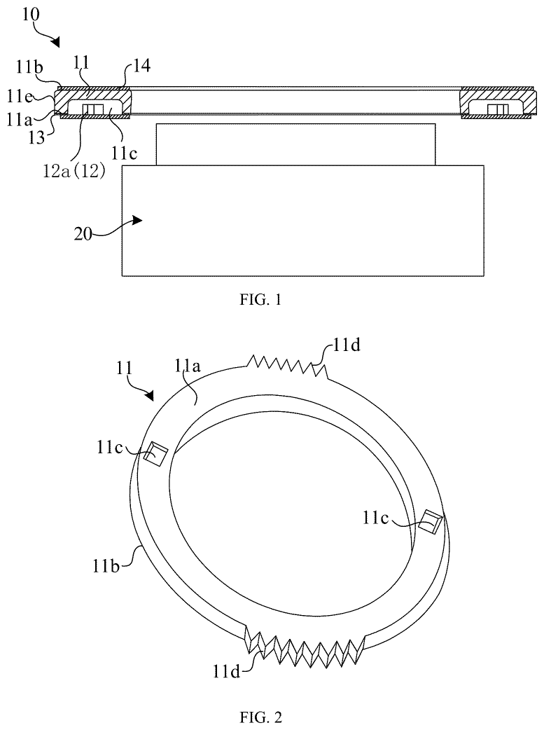

As shown in FIG. 1, in some embodiments of the present disclosure, a breathing light module 10 may be applied to an electronic device such as a mobile phone, a tablet computer, a smartwatch, etc. The breathing light module 10 may be configured to indicate information. For example, in scenarios such as incoming call display, text message notifications, and charging indicators during the use of the electronic device, the breathing light module 10 may flash to provide a reminder effect.

As shown in FIGS. 1 and 2, the breathing light module 10 includes a light guide element 11, a light source assembly 12, a first reflective film 13, and a second reflective film 14. The light guide element 11 has a first annular surface 11a and a second annular surface 11b arranged on two opposite sides. A groove 11c is defined on a side of the light guide element 11 where the first annular surface 11a is located. The light emitting portion 12a of the light source assembly 12 is at least partially arranged within the groove 11c, so that a light emitted from the light emitting portion 12a may enter the light guide element 11. The first reflective film 13 is arranged on the first annular surface 11a, and the second reflective film 14 is arranged on the second annular surface 11b. By using the first reflective film 13 and the second reflective film 14 to reflect the light and prevent the light from emitting from the first annular surface 11a and the second annular surface 11b may ensure that the light entering the light guide element 11 is emitted from a periphery of the light guide element 11. Thus, when a camera module 20 of the electronic device is arranged opposite the light guide element 11, the light emitted from the light guide element 11 is directed away from an optical axis of the camera module 20, which effectively reduces the likelihood of light crosstalk. Moreover, this structural setting may maintain the overall aesthetic appearance of the breathing light module 10.

It should be noted that a coverage area is formed by the second reflective film 14 covering on the second annular surface 11b, and an orthogonal projection of the light emitting portion 12a on the second annular surface 11b falls within the coverage area. As a result, when the light source assembly 12 emits light, the second reflective film 14 may provide a good reflective effect, preventing the light guide element 11 from being brighter at a position directly opposite to the light source assembly 12 than the light guide element 11 being at other positions, thus avoiding the phenomenon of a bright spot.

Furthermore, the periphery of the light guide element 11 is arranged with a light concentrating portion 11d. The light concentrating portion 11d is configured to converge the light incident on the light concentrating portion 11d and emit the light from the periphery of the light guide element 11. In this way, although the light from the light source assembly 12 may weaken as it propagates to the light concentrating portion 11d, the light concentrating portion 11d has a focusing effect on the light, thus preventing the occurrence of a dark spot and effectively improving the uniformity of light emission from various positions along the periphery of the light guide element 11.

The light concentrating portion 11d includes multiple sawteeth. The multiple sawteeth are arranged sequentially along the periphery of the light guide element 11. When the light propagating through the light guide element 11 exits from the light concentrating portion 11d, the multiple sawteeth may converge the light, enabling the light emitted from a position corresponding to the light concentrating portion 11d to be bright. This solves the problem of decreased light flux resulting in dimness, which occurs due to light loss during a propagation of the light emitted from the light source assembly 12 along the light guide element 11.

In some embodiments, the light guide element 11 has at least two grooves 11c defined thereon. The periphery of the light guide element 11 is arranged with at least two light concentrating portions 11d. The grooves 11c and the light concentrating portions are alternatively arranged along a circumferential direction of the light guide element 11. When the light emitted from the light emitting portion 12a at the groove 11c propagates through the light guide element 11 to the corresponding light concentrating portion 11d, the light concentrating portion 11d may have a focusing effect on the light, thereby preventing the occurrence of shadows and dark spots at a position corresponding to the light concentrating portion 11d.

Furthermore, any interval between any one of the at least two grooves 11c and an adjacent one of the at least two light concentrating portions 11d is equal, so as to improve the uniformity of the light emitted from the light guide element 11, enabling an annular light effect emitted by the breathing light module 10 to be softer and preventing the occurrence of local bright spots or dark spots.

It should be noted that the light emitted by the light source assembly 12 may be monochromatic light or multi-colored light. In some embodiments, the light source assembly 12 include a LED light. A position of a light emitting surface of the LED light forms the light emitting portion 12a. The LED light include at least one of a red LED light 121, a green LED light 122, and a blue LED light 123. It can be understood that the red LED light 121 is configured to emit red light, the green LED light 122 is configured to emit green light, and the blue LED light 123 is configured to emit blue light. Accordingly, when the red LED light 121 and the green LED light 122 emit light simultaneously, a mixed color light formed by the red light and the green light may be obtained; when the red LED light 121 and the blue LED light 123 emit light simultaneously, a mixed color light formed by the red light and the blue light may be obtained. In this way, the breathing light module 10 may emit mixed color effects, and thus enhancing the expressiveness.

A color mixing principle of two different colored lights will be explained below as shown in FIG. 3.

As shown in FIG. 3, when the angle θ between two light points (i.e., bright spots emitted by two different colored LED lights) and a line of sight of a human eye is sufficiently large, the human eye may distinguish that these are two separate light points. When the angle θ between the two light points and the line of sight of the human eye is sufficiently small, the human eye may perceive them as one single point. This critical angle is called a minimum resolvable angle of the human eye, which is approximately one minute of angle. It can be understood that as 1 degree equals to 60 minutes of angle, the minimum resolvable angle of the human eye is approximately (1/60) degree. When the angle formed by the two light points to the human eye is smaller than the minimum resolvable angle, images will overlap and appear as a single point, and a color of the point is a mixture of the colors of the two light points.

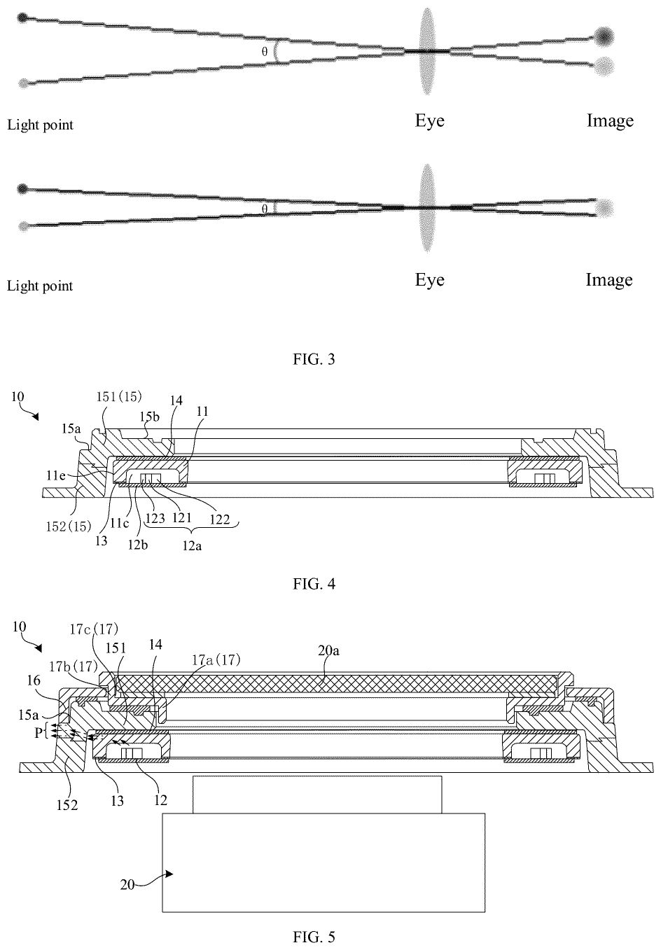

As shown in FIG. 4, the breathing light module 10 further includes a lightshade 15. The lightshade 15 includes a light-transmitting portion 151 and a light-blocking portion 152 connected together. The lightshade 15 covers the second annular surface 11b of the light guide element 11 and the peripheral side surface 11e of the light guide element 11 for enabling at least a part of the light-transmitting portion 151 to face the light guide element 11. It can be understood that the peripheral side surface 11e of the light guide element 11 is a surface located on an outer periphery of the first annular surface 11a and the second annular surface 11b of the light guide element 11. When the light emitting portion 12a emits light, the light guide element 11 directs the light from the periphery to the light-transmitting portion 151, and the light is emitted from the periphery of the light-transmitting portion 151. Since the light emitted from the light guide element 11 is directed from the periphery, and the light-transmitting portion 151 also emits light from a periphery of the light-transmitting portion 151. Thus when the breathing light module 10 emits light, the light emitted by the breathing light module 10 appears to radiate from the periphery of the breathing light module 10 the light emitted by the breathing light module 10 appears to be emitted from the periphery of the breathing light module 10 that is away from a center of the light guide element 11. As a result, the light will not enter the camera module 20 located at the center of the light guide element 11, thereby reducing the likelihood of light crosstalk.

Furthermore, the light-transmitting portion 151 and the light-blocking portion 152 are integrally formed through dual-color injection molding, which may maintain the overall structural strength and facilitate processing. In some embodiments, the light-transmitting portion 151 is made of transparent PC1250Z injected plastic material with 1% of white titanium dioxide and 1% of T150 diffusion powder. The light-blocking portion 152 is made of gray PC1414 injected plastic material with 1% of white titanium dioxide, enabling the light-blocking portion 152 to have low light transmission. Both the light-transmitting portion 151 and the light-blocking portion 152 are made from pelletized materials to ensure consistency of colorants. It should be noted that a light-block effect of the light-blocking portion 132 may be achieved with the aforementioned materials. In some embodiments, the light-blocking effect of the light-blocking portion 152 may also be achieved by attaching a light-blocking film. For example, the lightshade 15 may be made of transparent plastic or transparent glass, with a light-blocking film attached to a position near a lower part of the lightshade 15 and that corresponds to the light emitting portion 12a, so that the position covered by the light-blocking film may not transmit light, or the light flux passing through is negligible, thereby forming the light-blocking portion 152. Alternatively, the light-blocking portion 152 may be formed by spraying ink (such as black ink) onto the lightshade 15. The present disclosure does not limit the method for forming the light-blocking portion 152.

In some embodiments of the present disclosure, taking the example where three different colored LED lights are arranged in the groove 11c, as shown in FIGS. 4 and 5, after passing through the light guide element 11, the light emitted by these LED lights in the groove 11c is converged again to form a luminous area P on the surface of the breathing light module 10 (e.g., an outer surface of the lightshade 15. It can be understood that the further the light source assembly 12 is from the luminous area P, the smaller the angle θ of the mixed colors becomes. Simulation results show that when a distance between the light source assembly 12 and the luminous area P exceeds 5 mm, the human eye may not distinguish original colors of the three different colored LED lights, thereby achieving a good color mixing effect.

In some embodiments, as shown in FIG. 4, the red LED light 121, green LED light 122, and blue LED light 123 are arranged side by side within the groove 11c. The green LED light 122 is arranged on an inner side of the red LED light 121, and the blue LED light 123 is arranged on an outer side of the red LED light 121. The inner side of the red LED light 121 faces the center of the light guide element 11. In some embodiments, the green LED light 122, which has a longer wavelength, is arranged on the inner side, i.e., on a side of the light guide element 11 far from the lightshade 15, thereby avoiding the issue of a greenish tint in the mixed color effect.

In some embodiments, a light transmission rate of the light guide element 11 is 40% to 60%, and the thickness is 0.65 mm to 0.75 mm. It should be noted that in some embodiments, 9% to 11% by weight of diffusion powder is added to the material of the light guide element 11, which increases a refraction path of light within the light guide element 11, thereby further increasing a mixing distance between the light emitted by different colored LED lights, making the color mixing effect more uniform and preventing the issue of localized color deviation. The specific diffusion powder may be Lumiplas LD7750 (LGLD7750), the weight percentage of which in the material of the light guide element 11 may be 9%, 10% or 11%. A main material of the light guide element 11 may be polycarbonate to achieve good light transmission effects. For example, the material of the light guide element 11 may include Teijin PC-L-1225Y, and the weight percentage of Teijin PC-L-1225Y in the material of the light guide element 11 may be 90%. The material of the light guide element 11 will not be repeated here.

In some embodiments, a reflectance of the first reflective film 13 and a reflectance of the second reflective film 14 are both greater than or equal to 80%. A light transmission rate of the first reflective film 13 is 0.3% to 0.5%, and a light transmission rate of the second reflective film 14 is 0.2% to 0.4%. This allows the reflectance and light transmission rate of the first reflective film 13 and the second reflective film 14 to be controlled within suitable ranges, facilitating good reflective effects and ensuring that the light entering the light guide element 11 is emitted from the periphery of the light guide element 11. The materials of the first reflective film 13 and the second reflective film 14 may specifically be white PET. In some embodiments, the first reflective film 13 is double-sided adhesive tape, and the second reflective film 14 is single-sided adhesive tape, which makes it easier to attach the first reflective film 13 to the first annular surface 11a, and attach the second reflective film 14 to the second annular surface 11b.

As shown in FIG. 4, when the first reflective film 13 is double-sided adhesive tape, after the first reflective film 13 is attached to the first annular surface 11a, a circuit board 12b of the light source assembly 12 may be bonded to a side of the first reflective film 13 facing away from the light guide element 11. It can be understood that the LED light of the light source assembly 12 may be arranged on the circuit board by methods such as surface-mounting or adhesive bonding. As the circuit board is adjacent to the light guide element 11, the LED light is arranged in the groove 11c.

As shown in FIGS. 4 and 5, a first stepped groove 15a and a second stepped groove 15b are defined on the light-transmitting portion 151. The first stepped groove 15a is configured to arrange a first decorative ring 16 therein, and the second stepped groove 15b is configured to arrange a second decorative ring 17 therein. The first decorative ring 16 is sealingly connected to a top surface of the light-transmitting portion 151, and the second decorative ring 17 is sealingly connected to a step surface of the second stepped groove 15b, thus effectively ensuring an internal sealing of the breathing light module 10, facilitating waterproof and dustproof protection for the light source assembly 12 and the camera module 20 arranged inside. It should be noted that the light guide element 11 is arranged on a side of the light-transmitting portion 151 opposite to the second stepped groove 15b, and the inner circle of the light guide element 11 corresponds to the inner circle of the second decorative ring 17, enabling external light to pass through the second decorative ring 17 and the light guide element 11, eventually entering the camera module 20. It should be noted that in the present disclosure, the “inner circle” refers to a ring formed by an inner side wall of an annular structural member, and the “outer circle” refers to a ring formed by an outer side wall of an annular structural member. Taking the light guide element 11 as an example, the inner circle of the light guide element 11 is a ring formed by a sidewall of a central hole of the light guide element 11, and correspondingly, the outer circle of the light guide element 11 is a ring formed by a peripheral side surface 11e of the light guide element 11.

An installation groove 17c is defined on the second decorative ring 17. The installation groove 17c is configured to install a camera lens 20a. The camera lens 20a faces the camera module 20, and the camera lens 20a serves the purposes of beautification, decoration, and protection. It should be noted that the camera lens 20a may be connected to the second decorative ring 17 by optical adhesive or it may be snap-fitted within the installation groove 17c. The present disclosure does not limit this.

In some embodiments, the second decorative ring 17 includes a first stop wall 17a and a second stop wall 17b. The first stop wall 17a is arranged on the inner circle of the second decorative ring 17, and the second stop wall 17b is arranged on the outer circle of the second decorative ring 17. The first stop wall 17a abuts the inner circle of the light-transmitting portion 151, and the second stop wall 17b abuts the inner circle of the first decorative ring 16. This structural arrangement is compact, and the second decorative ring 17 is less likely to become loose from the first decorative ring 16, resulting in a robust overall structure for the breathing light module 10 with high impact resistance.

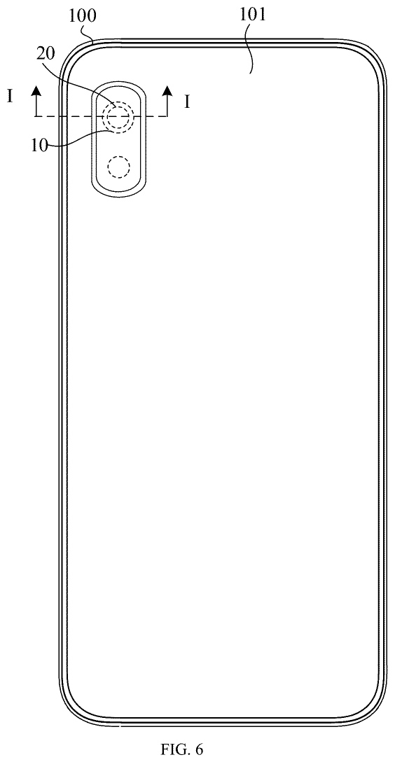

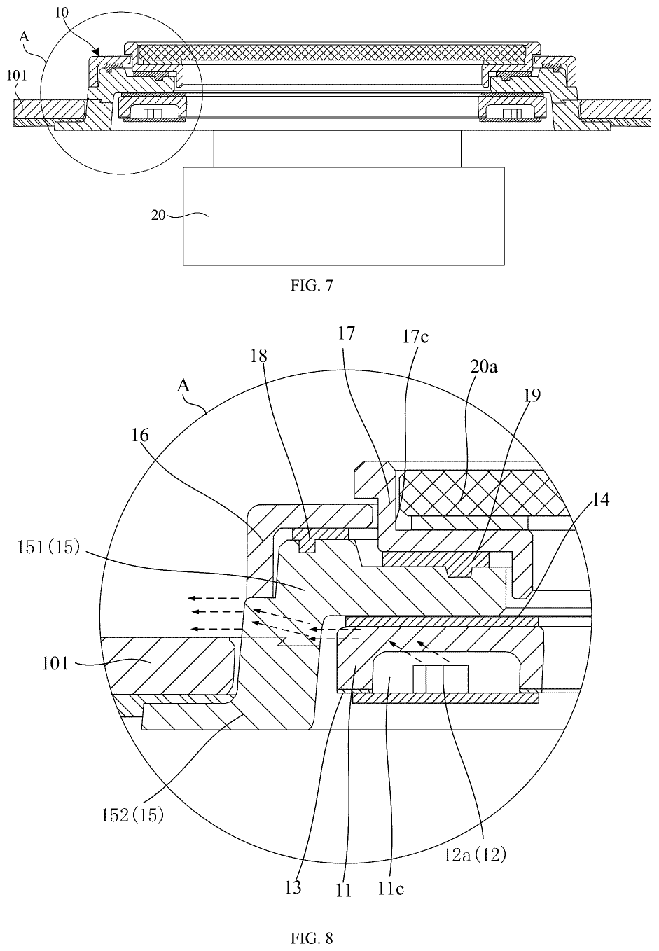

As shown in FIGS. 6 and 7, in some embodiments, the present disclosure provides an electronic device 100 that includes the above-described breathing light module 10. The electronic device 100 further includes the camera module 20, with the camera module 20 arranged facing the light guide element 11, and the light guide element 11 arranged to surround the optical axis of the camera module 20. When the breathing light module 10 operates, the light is emitted from the periphery of the light guide element 11, which does not enter the camera module 20, and thus effectively reducing the likelihood of light leakage during operation. At the same time, when the breathing light module 10 works, it may form an annular light effect around the camera module 20, enhancing the overall aesthetic appearance and improving the user experience.

As shown in FIGS. 7 and 8, in some embodiments where the breathing light module 10 includes the lightshade 15, the first decorative ring 16, and the second decorative ring 17, the first decorative ring 16 is connected to the lightshade 15 via a first adhesive layer and the second decorative ring is connected to the lightshade 15 via a second adhesive layer 19. The first adhesive layer 18 and the second adhesive layer 19 may be formed by curing adhesive or may be double-sided adhesive tape. The present disclosure does not limit this.

An outer side of the lightshade 15 may be connected to a casing of the electronic device 100 (e.g., a rear cover 101) via adhesive or double-sided tape, thereby installing the entire breathing light module 10 onto the electronic device 100. It can be understood that a region of the light-transmitting portion 151 from which the light emitted (i.e., the luminous area P) is exposed between the rear cover 101 and the first decorative ring 16, so that when the breathing light module 10 operates to emit light, an annular light effect is formed around the periphery of the light-transmitting portion 151.

In some embodiments, the lightshade 15 may also be connected to a front cover of the electronic device 100. The light guide element 11 is arranged to correspond to a front-facing camera. In this case, the breathing light module 10 may form an annular light effect around the front-facing camera.

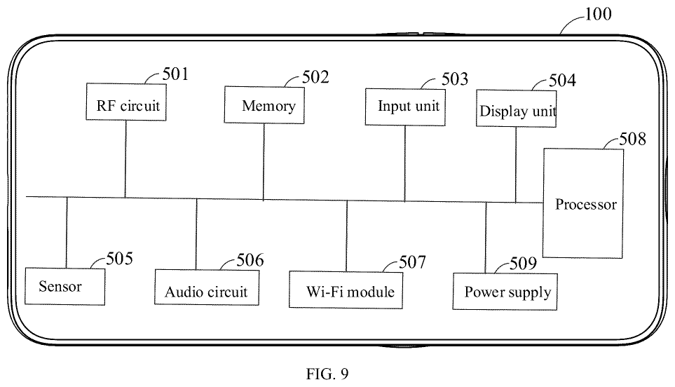

As shown in FIG. 9, FIG. 9 is a schematic structural view of the electronic device 100 in some embodiments of the present disclosure. The electronic device 100 may include a radio frequency (RF) circuit 501, a memory 502 with one or more computer-readable storage media, an input unit 503, a display unit 504, a sensor 505, an audio circuit 506, a wireless fidelity (Wi-Fi) module 507, a processor 508 with one or more processing cores, a power supply 509, etc. Those skilled in the art should understand that the structure of the electronic device 100 shown in FIG. 9 does not limit the structure of the electronic device 100; it may include more or fewer components than those shown, or some components may be combined, or different component arrangements may be used.

The radio frequency (RF) circuit 501 is configured to receive and transmit information or a signal during a call. In particular, after receiving downlink information from a base station, it sends the information to one or more processors 508 for processing. Additionally, it transmits uplink data to the base station. Generally, the RF circuit 501 includes, but is not limited to an antenna, at least one amplifier, a tuner, one or more oscillators, a Subscriber Identity Module (SIM) card, a transceiver, a coupler, a Low Noise Amplifier (LNA), a duplexer, etc. Furthermore, the RF circuit 501 may communicate with networks and other devices via wireless communication. The wireless communication may use any communication standard or protocol, including but not limited to the Global System for Mobile Communications (GSM), General Packet Radio Service (GPRS), Code Division Multiple Access (CDMA), Wideband Code Division Multiple Access (WCDMA), Long Term Evolution (LTE), email, Short Message Service (SMS), etc.

The memory 502 is configured to store an application and data. The application stored in the memory 502 includes an executable code. The application may form various functional modules. The processor 508 executes various functional applications and data processing by running the application stored in the memory 502. The memory 502 may primarily include a program storage area and a data storage area. The program storage area stores an operating system and at least one application required for a function (such as audio playback, image playback, etc.). The data storage area stores data created during the use of the electronic device 100 (such as audio data, contacts, etc.). Additionally, the memory 502 may include high-speed random access memory and non-volatile memory, such as at least one disk storage device, flash memory, or other volatile solid-state storage devices. Accordingly, the memory 502 may also include a memory controller to provide access to the memory 502 by the processor 508 and the input unit 503.

The input unit 503 is configured to receive input of digital information, character information, or user characteristic information (such as fingerprints), as well as generate signals from an input device such as a keyboard, a mouse, a joystick, an optical sensor, or a trackball related to user settings and function control. In some embodiments, the input unit 503 may include a touch-sensitive surface and other input devices. The touch-sensitive surface, also known as a touch screen or a touchpad, may detect user touch operations on or near the touch-sensitive surface (such as an operation of on or near the touch-sensitive surface by using a finger, a stylus or any suitable object or accessory. The touch-sensitive surface also drives corresponding connected devices according to pre-programmed instructions. In some embodiments, the touch-sensitive surface may include a touch detection device and a touch controller. The touch detection device is configured to detect a touch position of the user and a signal generated by the touch operation and transmit the signal to the touch controller. The touch controller receives touch information from the touch detection device, converts it into a touch point coordinate, and sends it to the processor 508. The touch controller may also receive and execute a command sent by the processor 508.

Furthermore, the touch-sensitive surface may cover a liquid crystal panel. When the touch-sensitive surface detects a touch operation on or near it, the touch information is sent to the processor 508 to determine a type of touch event. The processor 508 then provides a corresponding visual output on the liquid crystal panel based on the type of touch event.

The display unit 504 is configured to display information input by the user or provided to the user, as well as various graphical user interfaces of the electronic device 100. These graphical user interfaces may be composed of graphics, text, icons, videos, or any combination thereof. The display unit 504 may include the breathing light module 10 mentioned above.

Although in FIG. 9, the touch-sensitive surface and the liquid crystal panel are implemented as two separate components for input and output functions, in some embodiments, the touch-sensitive surface and the liquid crystal panel may be integrated to achieve both input and output functions. It can be understood that the electronic device 100 may include both the input unit 503 and the display unit 504.

The electronic device 100 may also include at least one sensor 505, such as a proximity sensor, motion sensor, and other sensors. The proximity sensor can turn off the liquid crystal panel and/or backlight when the electronic device 100 is moved close to the user's ear. As one type of motion sensor, the gravity accelerometer can detect the magnitude of acceleration in various directions (typically in three axes). When stationary, it can detect the magnitude and direction of gravity, which can be used for applications such as detecting the orientation of the phone (e.g., switching between portrait and landscape modes, related games, magnetometer calibration for orientation), vibration recognition features (e.g., pedometer, tapping), and so on. Other sensors that the electronic device 100 may include, such as a gyroscope, barometer, hygrometer, thermometer, and infrared sensors, are not elaborated here.

The audio circuit 506 provides an audio interface between the user and the electronic device 100 through a speaker and microphone. The audio circuit 506 can convert the received audio data into electrical signals, transmit these signals to the speaker, and convert them into sound signals for output. On the other hand, the microphone converts the collected sound signals into electrical signals, which are received by the audio circuit 506, converted into audio data, and then output to the processor 508 for processing. The processed audio data is then transmitted via the RF circuit 501 to another electronic device 100 or stored in the memory 502 for further processing. The audio circuit 506 may also include a headphone jack to provide communication between external headphones and the electronic device 100.

Wireless Fidelity (Wi-Fi) is a short-range wireless communication technology. The electronic device 100, through the Wi-Fi module 507, enables the user to send and receive emails, browse the web, and access streaming media, providing wireless broadband internet access to the user. Although FIG. 9 shows the Wi-Fi module 507, it can be understood that this is not an essential component of the electronic device 100 and can be omitted as needed without altering the scope of the invention.

The processor 508 is a control center of the electronic device 100, connecting various parts of the entire electronic device 100 through various interfaces and circuits. By running or executing applications stored in the memory 502 and accessing the data stored in the memory 502, it performs various functions and processes data, thereby providing overall control of the electronic device 100. In some embodiments, the processor 508 may include one or more processing cores. In some embodiments, the processor 508 may integrate an application processor and a modem processor, where the application processor primarily handles the operating system, user interface, and applications, and the modem processor primarily handles wireless communication. It can be understood that the modem processor may also not be integrated into the processor 508.

The electronic device 100 further includes a power supply 509 that powers the various components. In some embodiments, the power supply 509 may be logically connected to the processor 508 through a power management system, allowing the power management system to manage functions such as charging, discharging, and power consumption management. The power supply 509 may further include one or more direct current (DC) or alternating current (AC) power sources, one or more recharging systems, on or more power failure detection circuits, one or more power converters or inverters, one or more power status indicators, or any other components.

Although not shown in FIG. 9, the electronic device 100 may further include a Bluetooth module, which will not be repeated here. In practice, each of the above modules may be implemented as independent entities, or they may be combined in any way to form one or several entities. The specific implementation of these modules may be referenced from the earlier embodiments regarding methods, which will not be repeated here.

The technical features of the above embodiments may be combined in any way. For the sake of brevity, not all possible combinations of the technical features in the embodiments have been described. However, as long as the combinations of these technical features do not contradict each other, they should be considered within the scope of the description in this specification.

The above embodiments only illustrate several embodiments of the present disclosure, and their descriptions are specific and detailed, but should not be understood as limitations on the scope of the patent application. It should be noted that, for those skilled in the art, various modifications and improvements can be made without departing from the concept of the present disclosure, and these fall within the protection scope of the present disclosure. Therefore, the protection scope of this patent application should be determined by the appended claims.

1. A breathing light module, comprising:
a light guide element having a first annular surface and a second annular surface arranged on two opposite sides respectively, wherein a groove is defined on a side of the light guide element where the first annular surface is located;
a light source assembly, wherein a light emitting portion of the light source assembly is at least partially arranged within the groove, and the light emitting portion is configured to emit light towards the light guide element;
a first reflective film, arranged on the first annular surface; and
a second reflective film, arranged on the second annular surface, wherein a coverage area is formed by the second reflective film covering on the second annular surface, and an orthogonal projection of the light emitting portion on the second annular surface falls within the coverage area.

2. The breathing light module as claimed in claim 1, wherein a periphery of the light guide element is arranged with a light concentrating portion, the light concentrating portion is configured to converge the light incident on the light concentrating portion and emit the light from the periphery of the light guide element.

3. The breathing light module as claimed in claim 2, wherein the light concentrating portion comprises a plurality of sawteeth, and the plurality of sawteeth are sequentially arranged along the periphery of the light guide element.

4. The breathing light module as claimed in claim 2, wherein the light guide element has at least two grooves defined thereon, the periphery of the light guide element is arranged with at least two light concentrating portions, and the grooves and the light concentrating portions are alternatively arranged along a circumferential direction of the light guide element.

5. The breathing light module as claimed in claim 4, wherein any interval between any one of the at least two grooves and an adjacent one of the at least two light concentrating portions is equal.

6. The breathing light module as claimed in claim 1, wherein the light source assembly comprises a LED light, a position of a light emitting surface of the LED light forms the light emitting portion, and the LED light comprises at least one of a red LED light, a green LED light, and a blue LED light.

7. The breathing light module as claimed in claim 6, wherein the red LED light, the green LED light, and the blue LED light are arranged in parallel in the groove, the green LED light is arranged at an inner side of the red LED light, the blue LED light is arranged at an outer side of the red LED light, and the inner side of the red LED light is a side facing a center of the light guide element.

8. The breathing light module as claimed in claim 1, wherein the breathing light module further comprises a lightshade, the lightshade comprises a light-transmitting portion and a light-blocking portion connected together, the lightshade covers the second annular surface and a peripheral side surface of the light guide element for enabling at least a part of the light-transmitting portion to face the light guide element; in condition of the light emitting portion emitting the light, the light guide element directs the light from a periphery of the light guide element to the light-transmitting portion, and then the light is emitted from a periphery of the light-transmitting portion.

9. The breathing light module as claimed in claim 8, wherein the light-transmitting portion and the light-blocking portion are integrally formed through dual-color injection molding.

10. The breathing light module as claimed in claim 8, wherein the light-transmitting portion is made of transparent Polycarbonate 1250Z (PC) injected plastic material with 1% of white titanium dioxide and 1% of Ethylhexyl Triazone (T150) diffusion powder, and the light-blocking portion is made of gray PC1414 injected plastic material with 1% of white titanium dioxide.

11. The breathing light module as claimed in claim 8, wherein the lightshade is made of transparent plastic or transparent glass, and a light-blocking film is attached on a position of the lightshade corresponding to the light emitting portion, a position where the light-blocking film is attached forms the light-blocking portion, or the light-blocking portion is formed by ink sprayed onto the lightshade.

12. The breathing light module as claimed in claim 1, wherein a light transmission rate of the light guide element is 40% to 60%, and a thickness of the light guide element is 0.65 mm to 0.75 mm.

13. The breathing light module as claimed in claim 1, wherein a reflectance of the first reflective film and a reflectance of the second reflective film are both greater than or equal to 80%, a light transmission rate of the first reflective film is 0.3% to 0.5%, and a light transmission rate of the second reflective film is 0.2% to 0.4%.

14. The breathing light module as claimed in claim 13, wherein a material of the first reflective film and the second reflective film is white Polyethylene Terephthalate (PET).

15. The breathing light module as claimed in claim 13, wherein the first reflective film is double-sided adhesive tape, and the second reflective film is single-sided adhesive tape.

16. The breathing light module as claimed in claim 8, wherein a first stepped groove and a second stepped groove are defined on the light-transmitting portion, the first stepped groove is configured to arrange a first decorative ring therein, the second stepped groove is configured to arrange a second decorative ring therein, the first decorative ring is sealingly connected to a top surface of the light-transmitting portion, the second decorative ring is sealingly connected to a step surface of the second stepped groove, the light guide element is arranged on a side of the light-transmitting portion opposite to the second stepped groove, and an inner circle of the light guide element corresponds to an inner circle of the second decorative ring.

17. The breathing light module as claimed in claim 16, wherein an installation groove is defined on the second decorative ring, and the installation groove is configured to install a camera lens.

18. The breathing light module as claimed in claim 16, wherein the second decorative ring comprises a first stop wall and a second stop wall, the first stop wall is arranged on the inner circle of the second decorative ring, the second stop wall is arranged on an outer circle of the second decorative ring, the first stop wall abuts an inner circle of the light-transmitting portion, and the second stop wall abuts an inner circle of the first decorative ring.

19. The breathing light module as claimed in claim 16, wherein the breathing light module further comprises a first adhesive layer and a second adhesive layer, the first decorative ring is connected to the lightshade via the first adhesive layer, and the second decorative ring is connected to the lightshade via the second adhesive layer.

20. An electronic device, comprising:
a camera module and a breathing light module, wherein the breathing light module comprises:
a light guide element having a first annular surface and a second annular surface arranged on two opposite sides respectively, wherein a groove is defined on a side of the light guide element where the first annular surface is located;
a light source assembly, wherein a light emitting portion of the light source assembly is at least partially arranged within the groove, and the light emitting portion is configured to emit light towards the light guide element;
a first reflective film, arranged on the first annular surface; and
a second reflective film, arranged on the second annular surface, wherein a coverage area is formed on the second annular surface by a cover of the second reflective film, and an orthogonal projection of the light emitting portion on the second annular surface falls within the coverage area;
wherein the camera module faces the light guide element, and the light guide element is arranged to surround an optical axis of the camera module.
